(19) United States
(12) Patent Application Publication
(10) Pub. No.: US 2018/0071054 A1
(43) Pub. Date: Mar. 15, 2018

(54) APPARATUS AND METHOD FOR CORRECTING ORTHODONTIC MALOCCLUSIONS

(71) Applicant: Dang Ha, Odessa, FL (US)

(72) Inventor: Dang Ha, Odessa, FL (US)

(21) Appl. No.: 15/698,680

(22) Filed: Sep. 8, 2017

Related U.S. Application Data
(60) Provisional application No. 62/495,426, filed on Sep. 14, 2016.

(51) Int. Cl. A61C 7/00; A61C 7/08

(52) U.S. Cl. CPC A61C 7/006; A61C 7/08

(57) ABSTRACT

A sequential orthodontic appliance includes a body and one or more first magnets disposed on the body and arranged to provide either repulsive or attractive force between one or more second magnets disposed on a surface of a tooth in need of repositioning. One or more temporary anchorage devices are used to secure the appliance to a person with the body disposed approximate the tooth.

### CROSS-REFERENCE TO RELATED APPLICATION

This application claims the benefit of U.S. Provisional Application No. 62/495,426, filed Sep. 14, 2016, the entirety of which is incorporated herein by reference.

### FIELD OF THE INVENTION

The present invention relates to the correction of orthodontic malocclusions and, more particularly, correcting malocclusions using magnet force between magnets disposed on a removable appliance and corresponding magnets placed on the teeth.

### BACKGROUND OF THE INVENTION

Malocclusion is a misalignment or incorrect relation between the upper and lower teeth when the jaw closes. Orthodontic treatment is used to correct teeth and jaw positioning so that the upper and lower teeth fit together properly. Historically, orthodontic treatment to correct malocclusion has been accomplished by using direct contact, static force to induce bone remolding and teeth repositioning. The most common method is braces, which have an archwire interface with brackets that are affixed to each tooth. Force generated by the archwire causes the teeth to move into a desire position. While effective, braces have several disadvantages, including aesthetic appearance, generally painful, and unable to move teeth with exact precision.

Fairly recently a new technique using sequential removable appliances was developed to as an alternative to traditional braces. The appliances are formed from transparent plastic material which is more aesthetically pleasing. The appliances are designed to directly contact the teeth and apply a static force to the teeth, like how the archwire in braces work. As the teeth move, the appliance needs to be replaced with a new one to designed to correspond to the current position of the teeth and the appliances generally need to be replaced every few weeks. An example of a sequential removable appliance is described in U.S. Pat. No. 6,217,325, the entirety of which is incorporated herein by reference.

Like braces, sequential appliances have several disadvantages. Most significantly, sequential appliances are only effective at correcting relative minor malocclusions due to the inability to grip the teeth with sufficient force to correct more severe misalignments. For instance, it is difficult to correct rotation of a cylindrical tooth, such as molars, and to move teeth vertically using sequential appliances.

Other related art in this field include the following:

U.S. Pat. No. 3,984,915 discloses a system for repositioning teeth using magnetic force by bonding magnets to teeth that need repositioning and to adjacent teeth to create either an attractive or replying force between the teeth.

U.S. Published Application. No. 2016/0346064 discloses a system for producing orthodontic appliances using computer-aided design and 3D printing, the entirety of which is incorporated herein by reference.

U.S. Published Application No. 2017/0100214 discloses an orthodontic planning system for treating teeth to correct for malocclusions by creating a computer scan of a subject's dentition, determining a treatment plan having a plurality of incremental movements for repositioning one or more teeth, and fabricating one or more appliances, the entirety of which is incorporated herein by reference.

U.S. Published Application No. 2008/0085489 discloses a method of making a computer model of a patient's jaws and manufacturing surgical guides from the computer model, the entirety of which is incorporated herein by reference.

### SUMMARY OF THE INVENTION

Embodiments of the present invention provide a system and method for correcting malocclusions by applying a magnetic force to one or more teeth needing repositioning. The subject wears a series of custom designed appliances, each having magnets that are strategically located thereon to provide either attractive or repulsive force with corresponding magnets bonded to one or more teeth needing repositioning.

In aspects, the embodiments of the present invention include digitally scanning the subject's dentition to create a 3D model of the subject's teeth and bone structure, planning a treatment including sequentially moving one or more teeth to a desired position, and fabricating a plurality of appliances for sequentially moving the one or more teeth in to the desired position. The one or more appliances are fabricated by 3D printing based upon the computer model of the subject and the treatment plan. The appliances are designed to be successively worn and to incrementally reposition the teeth from a starting position to a final position.

In other aspects, the appliances are attached to the subject's dental arch using one or more temporary anchor devices (TADs) to provide necessary anchoring of the appliance. Surgical guides are created using the computer model of the subject and are used to assist in placement and attachment of one or more TAD on the subject's dental arch bone structure. The appliances are removably attached to the TADs to allow replacement of each sequential appliance.

In general, in one aspect, a method for correcting orthodontic malocclusion comprising the steps of:
a. receiving a three-dimensional scan of a person's dentition;
b. determining a treatment plan having a plurality of incremental movements for repositioning one or more teeth of the person's dentition according to the three-dimensional scan;
c. fabricating one or more appliances correlating to a desired set of incremental movements of one or more teeth, each of the one or more appliances having one or more first magnets affixed thereto;
d. fabricating a surgical guide according to the three-dimensional scan of the person's dentition;
e. attaching a temporary anchorage device at each corner of the person's dental arch using the surgical guide;
f. affixing one or more second magnets to one or more teeth of the person according to the desired set of incremental movements;
g. fitting a first appliance of the one or more appliances to the person by attaching the appliance to each of temporary anchorage device; and
h. allowing a sufficient time for movement of the tooth or teeth in need of repositioning caused by attraction or repulsion between one or more of the first magnets and one or more of the second magnets.

In general, in another aspect, a system for correcting orthodontic malocclusion is provided. The system includes an appliance having a body and one or more first magnets disposed on the body and arranged to provide either repulsive or attractive force between one or more second magnets disposed on a surface of a tooth in need of repositioning. One or more temporary anchorage devices are used to secure the appliance to a person with the body disposed approximate the tooth.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in many ways. Also, it is to be understood that the phraseology and terminology employed herein are for descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a diagrammatic plan view of a subject's upper jaw and teeth shown in connection with a system for correcting malocclusion using magnetic force and sequential appliances according to an embodiment of the present invention;

FIG. 2 is a diagrammatic, partial enlarged view of FIG. 1;

FIG. 3 is a diagrammatic, front elevation view of FIG. 1;

FIG. 4 is a diagrammatic, partial cross-sectional view taken along line 4-4 in FIG. 2; and

FIG. 5 is a diagrammatic, partial cross-sectional view taken along line 5-5 in FIG. 1.

### DETAILED DESCRIPTION OF THE INVENTION

Embodiments of the present invention provide a system and method for using magnetic force to incrementally move teeth using a plurality of individual appliances, where each appliance successively moves one or more teeth from a starting position to a final position according to a predetermined treatment plan based upon a computer model of the subject.

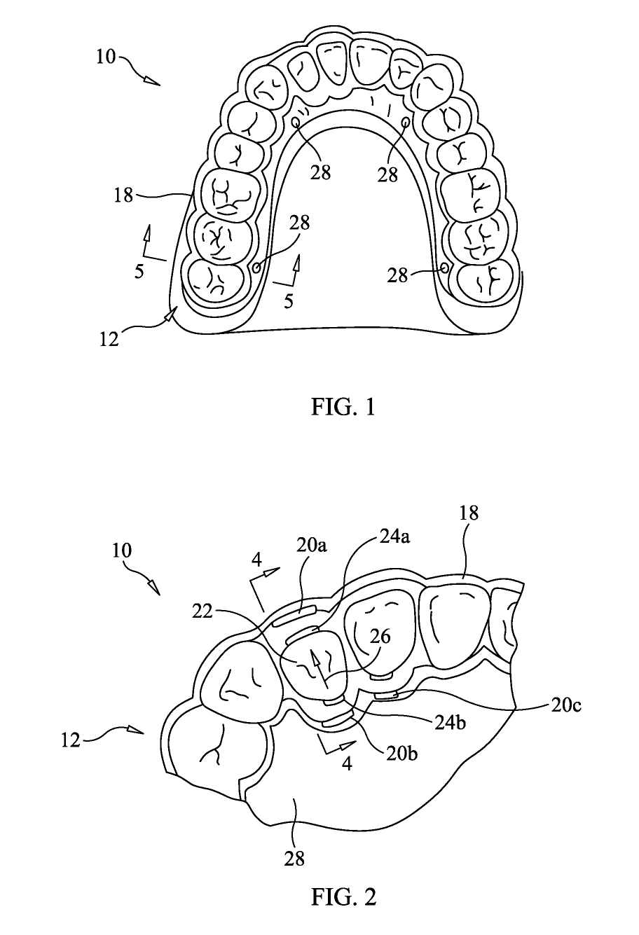

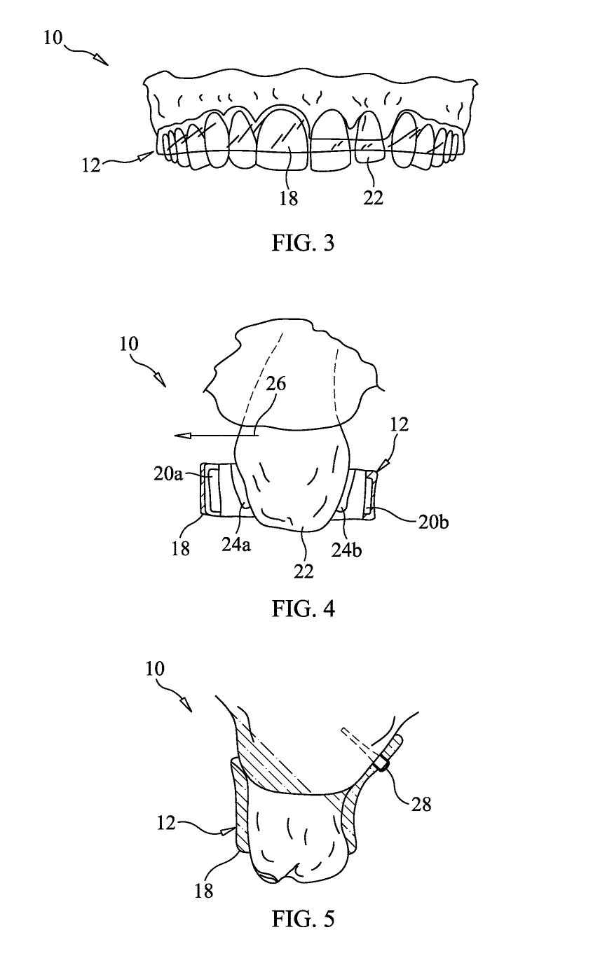

With reference now to FIGS. 1-5, there is representatively illustrated a set of teeth and a system 10 for repositioning one or more teeth using magnetic forces. The system includes an appliance 12, one or more first magnets 20a-20c disposed on the appliance 12, and one or more second magnets 24a-24b bonded to one or more teeth needing repositioning.

Representatively illustrated, the appliance 12 comprises a body 18 having a general loop form configured to generally follow the contour and shape of the subject's teeth. The body 18 is formed to contact vertical surfaces of the teeth that are not being moved and provide a space or gap between the body and the front and/or back surfaces of the teeth that are being repositioned. In the representative example, the body 18 has a relatively narrow, band-like profile that only overlaps a small vertical portion of the subject's teeth that are being repositioned. The front wall of the body 18 that overlaps teeth not being repositioned extends from about the middle of the front vertical surfaces of the teeth to the gum line. The back wall of the extends from about the middle of the back vertical surfaces of the teeth to the gum line and at least partially overlapping the gums, thereby providing an inwardly extending flange portion that extends along the back side of the appliance. In aspects, the body 18 is formed so that it does not cover any bite surfaces of the subject's teeth, thereby allowing the bite surfaces of the top and bottom teeth to engage when the subject closes his or her jaw.

While only a single appliance 12 is shown in the drawings, it is to be understood the system and method of the present invention includes two or more sequentially used appliances that are designed to incrementally move one or more teeth in steps from an initial position to a final position.

Each appliance 12 is precision fabricated as a single piece by computer-controlled manufacturing using a 3D printer based upon a 3D scanned image of the subject's dentition. The appliances 12 can be fabricated from transparent material or material having any desired color.

Each appliance 12 is fabricated according to a treatment plan developed from a digital model of the subjected created by a computer scan of the subject's dentition and bone structure, by coned beam computer tomography, for example. After the subject's dental anatomy has been created, CAD software can be used by an operator to design a set of appliances 12 for treatment of the subject. This typically includes selecting desired positions of the magnets on the appliance and subject's teeth in accordance with a plan to sequentially and incrementally move one or more of the subject's teeth.

As further illustrated, appliance 12 representatively includes magnets 20a, 20b, and 20c attached to the body 18 by being received and retained in corresponding slots or recesses formed into the body during fabrication of the appliance. As further shown, tooth 22 has magnets 24a and 24b bonded to the front and backsides, respectively, thereof.

Representatively, magnets 20a and 24a are arranged so that an attractive force is present between the two magnets and magnets 20b and 24b are arranged so that a repulsive force is present between the two magnets. To this end, tooth 22 is caused to move along the direction indicated by arrow 26. The dimensions, structure, number and composition of the magnets and their coating type or material will depend on space available, force level and type of movement needed. As discussed above, the invention is not limited to the movement shown in the drawings. The relative positioning of the magnets on the appliance and bonded to the teeth can be arranged to provide magnetic force required to achieve desired movement of the tooth or teeth.

Magnets are positioned on the appliance 12 and bonded to teeth surfaces in relative positions to create desired magnetic forces between the magnets to provide the mechanical force needed to achieve a desired movement of the tooth or teeth being repositioned. Such as, for example, to cause rotation, intrusion, extrusion, distalization, etc. of the tooth or teeth being repositioned.

In addition to anchoring provided to the appliance by contacting teeth not being repositioned, temporary anchorage devices 28 may also be used. The temporary anchorage devices 28 removably secure the appliance 12 on the subject's bone to securely position the appliance relative to the subject's teeth. The appliance 12 includes a mounting portion for each temporary anchorage device that removably engages the temporary anchorage device in a snap-fit type engagement.

In an example case, teeth are positioned into an ideal arch form with correct class 1 molar and canine relationship and correct condylar relationship. Once the final position of patient teeth and jaw relationship has been achieved, then the second part of appliance design and fabrication can start. With the teeth and jaw are in ideal position; the appliance will take the shape of the final corrected arch form. For example, if the original arch forms of a thumb habit patient is usually triangular in shape, and the corrected arch form is U shape, the final appliance shape will be U shape, hence as we move the keystone teeth into the correct position the V shape arch will take on a new shape of U shape. Once the appliance has been design to its specific function and has been virtually verified with the patient, the appliance can be then send laboratory for printing and magnet attachment, and final quality control before return case to clinician for final clinical portion.

Orthodontic teeth movement only occur when the force that needed to induce resorption of bone in the direction of point A to B is overcome by an external anchorage force. So, in order to overcome the anchorage force we need an anchorage devices to secure the appliance in place. The magnets on the appliance alone will not be able to move teeth until appliance and arch are attach as one unit. To achieve this total arch anchorage system, we use four temporary anchorage devices (TADs) to secure the appliance at four corners of the arch. As mention earlier the, as the laboratory technician design the appliance he/she also take into consideration of the location for TADs placement and attachment's slot for the appliance to the TADs. On the day of clinical appliance delivery, a surgical guide will be provided to clinician to precisely place the TADs. Correct placement of the TAD is critical, because the appliance will snap securely on to these four TADs. The precision fit of the TAD and appliance come together at the planning and designing stage.

Several embodiments of the present invention have been described. Nevertheless, it will be understood that various modifications may be made without departing from the spirit and scope of the invention. Accordingly, other embodiments are within the scope of the following claims.

What is claimed is:

1. A method for correcting orthodontic malocclusion comprising the steps of:
receiving a three-dimensional scan of a person's dentition;
determining a treatment plan having a plurality of incremental movements for repositioning one or more teeth of the person's dentition according to said three-dimensional scan;
fabricating one or more appliances correlating to a desired set of incremental movements of one or more teeth, each of said one or more appliances having one or more first magnets affixed thereto;
fabricating a surgical guide according to said three-dimensional scan of the person's dentition;
attaching a temporary anchorage device at each corner of the person's dental arch using said surgical guide;
affixing one or more second magnets to one or more teeth of the person according to said desired set of incremental movements;
fitting a first appliance of said one or more appliances to the person by attaching said appliance to each of temporary anchorage device; and
allowing a sufficient time for movement of the tooth or teeth in need of repositioning caused by attraction or repulsion between one or more of said first magnets and one or more of said second magnets.

2. The method of claim 1, wherein said one or more appliances are manufactured by 3D printing techniques.

3. The method of claim 1, wherein at least one of said one or more appliances is made of a transparent plastic material.

4. The method of claim 1, wherein said three-dimensional scan is cone beam computed tomography scan.

5. The method of claim 1, wherein at least one of said one or more appliances has a forward vertical surface and a rearward vertical surface, and wherein at least one of said one or more first magnets is disposed on one of said forward or rearward vertical surfaces.

6. The method of claim 1, wherein said appliance includes a body formed having a narrow band portion that overlaps the one or more teeth being repositioned with a gap between said narrow band portion and the one or more teeth being repositioned, and wherein said body is formed to contact vertical surfaces of one or more teeth not being repositioned without covering the bit surface of the one or more teeth.

7. A system for correcting orthodontic malocclusion comprising:
an appliance having a body;
one or more first magnets disposed on said body and arranged to provide either repulsive or attractive force between one or more second magnets disposed on a surface of a tooth in need of repositioning; and
one or more temporary anchorage devices for securing said appliance to a person with said body disposed approximate said tooth.

8. The system of claim 7, wherein said appliance is made of a transparent plastic by 3D printing.

9. The system of claim 7, further comprising a surgical guide used for affixing said one or more temporary anchorage devices to the person's bone.

10. The system of claim 7, further comprising:
a second appliance having a body shaped differently from said body of said first appliance; and
one or more second magnetics disposed on said body and arranged to provide either repulsive or attractive force between at least one of said one or more second magnets disposed.

11. The system of claim 10, wherein said second appliance is made of a transparent plastic by 3D printing.

12. The system of claim 7, wherein said body is formed to have a narrow band portion that overlaps the one or more teeth being repositioned with a gap between said narrow band portion and the one or more teeth being repositioned, and wherein said body is formed to contact vertical surfaces of one or more teeth not being repositioned without covering the bit surface of the one or more teeth.
